(19) United States
(12) Patent Application Publication
(10) Pub. No.: US 2015/0319332 A1
(43) Pub. Date: Nov. 5, 2015

(54) TERMINAL DEVICE, IMAGE-READING APPARATUS, INFORMATION PROCESSING SYSTEM, AND INFORMATION PROCESSING METHOD

(71) Applicant: PFU Limited, Kahoku-shi (JP)

(72) Inventors: Kazuya MIYASHITA, Ishikawa (JP); Hiroshi NISHIYAMA, Ishikawa (JP)

(21) Appl. No.: 14/458,857

(22) Filed: Aug. 13, 2014

(30) Foreign Application Priority Data
Apr. 30, 2014 (JP) 2014-094260

(51) Int. Cl. H04N 1/21; H04N 1/00

(52) U.S. Cl. CPC H04N 1/2187; H04N 1/00408; H04N 2201/0081; H04N 2201/0087; H04N 2201/21

(57) ABSTRACT

The present invention monitors images stored in a cloud storage and displays, in a list form distinctively, images stored only locally; images stored only in the cloud storage; the images that are stored in the cloud storage, that correspond to the images stored locally, and that are updated; and the images that are stored in the cloud storage, that correspond to the images stored locally, and that are not updated.

### CROSS-REFERENCE TO RELATED APPLICATION

This application is based upon and claims the benefit of priority from Japanese Patent Application No. 2014-094260, filed on Apr. 30, 2014, the entire contents of which are incorporated herein by reference.

### BACKGROUND OF THE INVENTION

1. Field of the Invention

The present invention relates to a terminal device, an image-reading apparatus, an information processing system, and an information processing method.

2. Description of the Related Art

Conventional technologies that clearly inform updates of scan data have been disclosed.

An image processing device has been disclosed that delivers a message indicating that image data is updated (refer to JP-A-2013-172424).

However, when files are updated, conventional information processing apparatuses (JP-A-2013-172424 and the like) add the latest message into a list in such a manner that file-related message display is stacked. Such apparatuses have a problem in that they are incapable of displaying the status of the files, operations that can be performed by users, and the like to the users simply and in an easily recognizable manner.

### SUMMARY OF THE INVENTION

It is an object of the present invention to at least partially solve the problems in the conventional technology.

A terminal device according to one aspect of the present invention includes an image storage unit that stores images, a monitoring unit that monitors images stored in a cloud storage, and a display controlling unit that displays, in a list form distinctively, the images stored only in the image storage unit, the images stored only in the cloud storage, the images that are stored in the cloud storage, that correspond to the images stored in the image storage unit, and that are updated, and the images that are stored in the cloud storage, that correspond to the images stored in the image storage unit, and that are not updated.

An image-reading apparatus according to another aspect of the present invention includes an image storage unit that stores images, an image acquiring unit that acquires images read by an image reading unit and stores the images in the image storage unit, a monitoring unit that monitors images stored in a cloud storage, and a display controlling unit that displays, in a list form distinctively, the images stored only in the image storage unit, the images stored only in the cloud storage, the images that are stored in the cloud storage, that correspond to the images stored in the image storage unit, and that are updated, and the images that are stored in the cloud storage, that correspond to the images stored in the image storage unit, and that are not updated.

An information processing system according to still another aspect of the present invention includes an image-reading apparatus, a terminal device, and a cloud storage that are communicably connected, the terminal device including an image storage unit that stores images, an image acquiring unit that acquires images read by the image reading apparatus and stores the images in the image storage unit, a monitoring unit that monitors images stored in the cloud storage, and a display controlling unit that displays, in a list form distinctively, the images stored only in the image storage unit, the images stored only in the cloud storage, the images that are stored in the cloud storage, that correspond to the images stored in the image storage unit, and that are updated, and the images that are stored in the cloud storage, that correspond to the images stored in the image storage unit, and that are not updated.

An information processing method according to still another aspect of the present invention is executed by a terminal device, the method comprising a monitoring step of monitoring images stored in a cloud storage, and a display controlling step of displaying, in a list form distinctively, images stored only in an image storage unit included in the terminal device, the images stored only in the cloud storage, the images that are stored in the cloud storage, that correspond to the images stored in the image storage unit, and that are updated, and the images that are stored in the cloud storage, that correspond to the images stored in the image storage unit, and that are not updated.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a hardware configuration diagram of an example of the configuration of an information processing system according to an embodiment;

FIG. 2 is a flowchart of an example of processing according to the information processing system of the present embodiment;

FIG. 3 is a diagram of an example of screen display according to the present embodiment;

FIG. 4 is a picture of an example of icons according to the present embodiment;

FIG. 5 is a picture of an example of icons according to the present embodiment;

FIG. 6 is a picture of an example of icons according to the present embodiment;

FIG. 7 is a picture of an example of icons according to the present embodiment;

FIG. 8 is a picture of an example of icons according to the present embodiment;

FIG. 9 is a picture of an example of icons according to the present embodiment;

FIG. 10 is a picture of an example of icons according to the present embodiment;

FIG. 11 is a picture of an example of icons according to the present embodiment; and

FIG. 12 is a flowchart of an example of processing according to an information processing system of the present embodiment.

### DETAILED DESCRIPTION OF THE PREFERRED EMBODIMENTS

The following explains embodiments of the terminal device, the image-reading apparatus, the information processing system, and the information processing method according to the preset invention in detail based on the drawings. The embodiments do not limit the present invention. In the present embodiment, although being explained as a manual document feeding (continuous document feeding (CDF)) document scanner or the like, the image-reading apparatus is not limited to this and may be an automatic document feeding (ADF) document scanner, a flatbed document scanner, an overhead image-reading apparatus, or the like. A method for processing images according to the present embodiment in particular can be used for images acquired by various image-reading apparatuses such as CDF document scanners, ADF document scanners, flatbed document scanners, and overhead image-reading apparatuses.

1. Configuration of Present Embodiment

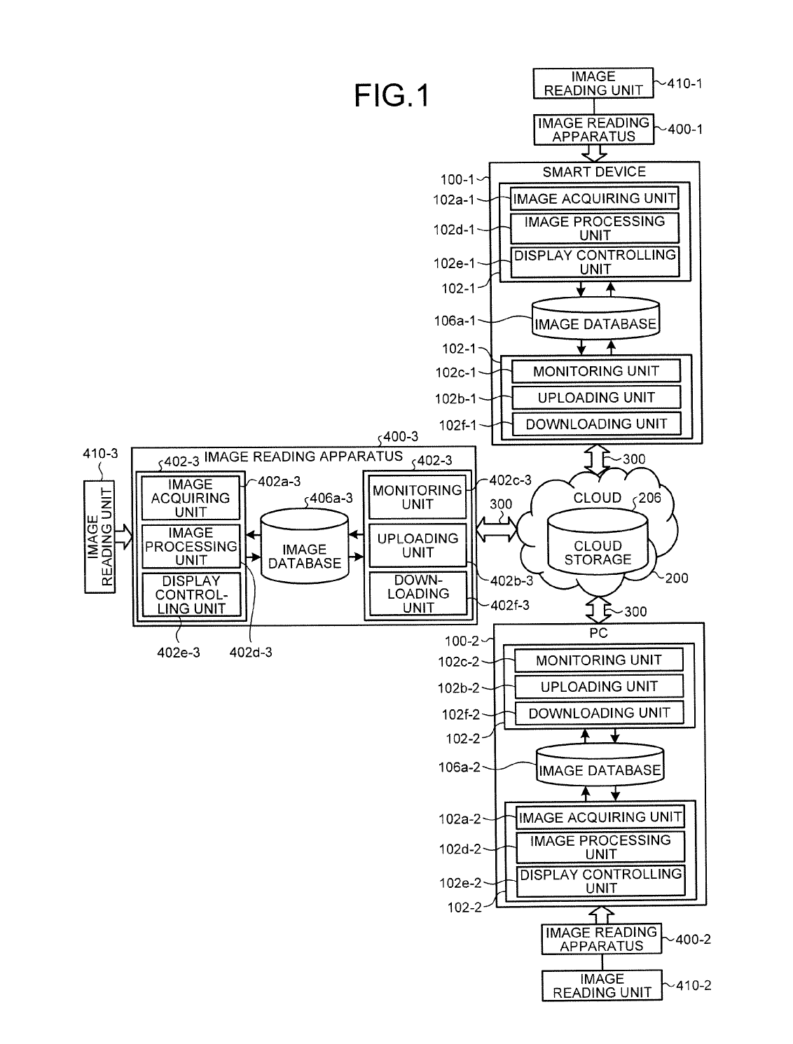

The following explains an example of the configuration of an information processing system according to the embodiment of the present invention with reference to FIG. 1 and then explains processing and the like of the present embodiment in detail. The following embodiment exemplifies an information processing system to embody the technical ideas of the present invention, and is not intended to limit the present invention to this information processing system. The embodiment can be equally used for information processing systems of other embodiments. For example, the manner of function distribution between a smart device (terminal device) 100-1 and a PC (terminal device) 100-2 is not limited to the following one and can be configured through functional or physical distribution and integration in any desirable unit to the extent that similar effects and functions can be produced. FIG. 1 is a hardware configuration diagram showing an example of the configuration of the information processing system according to the present embodiment.

As shown in FIG. 1, the information processing system of the present embodiment is generally configured by communicably connecting terminal devices 100 and a cloud 200. The terminal devices 100 (a smart device 100-1 and a PC 100-2) are communicably connected to an image-reading apparatus 400 (an image-reading apparatus 400-1 or an image-reading apparatus 400-2). The cloud 200 includes a cloud storage 206. Differences between the smart device 100-1 and the PC 100-2 may be differences in any one or both of the storage capacity and the processing capability of a CPU or the like. For example, the PC 100-2 may be a terminal device 100 having a larger storage capacity and a higher processing capability of a CPU or the like than the smart device 100-1.

As shown in FIG. 1, the information processing system of the present embodiment may be configured by directly communicably connecting the image-reading apparatus 400 (an image-reading apparatus 400-3) and the cloud 200. The communication includes, as an example, remote communication such as wired and wireless communication through a network 300. These units of the information processing system are communicably connected through any communication channels.

As shown in FIG. 1, the terminal device 100 generally includes a control unit 102 and a storage unit 106. Although omitted in FIG. 1, in the present embodiment, the terminal device 100 may further include an input/output unit (I/O unit) 112. The terminal device 100 may further include an input/output interface unit (not shown) that connects the input/output unit 112 and the control unit 102.

The terminal device 100 may further include a communication interface unit (not shown) and may be mutually communicably connected to an external apparatus (for example, any one or both of the cloud 200 and the image-reading apparatus 400) through the communication interface unit. The communication interface unit is an interface connected to a communication device such as any one or both of an antenna and a router connected to any one or both of a communication line and a telephone line and may have a function that performs communication control between the terminal device 100 and the network 300. The communication interface unit may be a network interface controller (NIC) or the like. These units are communicably connected through any communication channels. The control unit 102 may control the input/output unit (I/O unit) 112, the input/output interface unit, and the communication interface unit.

The storage unit 106 stores any one or both of various databases, various tables, and various files. The storage unit 106 is a storage unit, which may be, for example, a memory such as a RAM and a ROM, a fixed disk device such as any one or both of a hard disk, a flexible disk, and an optical disc. The storage unit 106 stores a computer program or the like that gives instructions to a central processing unit (CPU) to perform various kinds of processing.

Among these constituent elements of the storage unit 106, an image database 106a stores images. The images may be images read by the image-reading apparatus 400. The images may be images downloaded from the cloud 200. The images may be updated images. The updated images may be images subjected to image processing by a different terminal device 100, image-reading apparatus 400 (the image-reading apparatus 400-3 or the like), or the like. The image database 106a may store list information on the status of images stored in the cloud storage 206.

The input/output unit 112 performs the inputting and outputting (I/O) of data. The input/output unit 112 may be, for example, a key input unit, a touch panel, a control pad (for example, a touch pad or a game pad), a mouse, a keyboard, or a microphone. The input/output unit 112 may be a display unit (for example, a display including liquid crystals or organic electroluminescence (EL), a monitor, or a touch panel) that displays display screens for applications or the like. The input/output unit 112 may be a voice output unit (for example, a speaker) that outputs voice information as voices.

The control unit 102 includes a CPU or the like that comprehensively controls the terminal device 100. The control unit 102 has an internal memory for storing a control program, a program that prescribes various kinds of process procedures, and necessary data and performs information processing for executing various kinds of processing based on these programs.

The control unit 102 roughly includes an image acquiring unit 102a, an uploading unit 102b, a monitoring unit 102c, an image processing unit 102d, a display controlling unit 102e, and a downloading unit 102f.

The image acquiring unit 102a acquires images. The image acquiring unit 102a may acquire images read by the image-reading apparatus 400. The image acquiring unit 102a may store images or the like in the image database 106a. The image acquiring unit 102a may cause the image-reading apparatus 400 to read a medium (document) and acquire an image. The image acquiring unit 102a may cause the image-reading apparatus 400 to read a plurality of documents simultaneously and acquire a read image. In other words, the image acquiring unit 102a may control the image-reading apparatus 400 to acquire images. The image acquiring unit 102a, for example, may control the image-reading apparatus 400 to combine one-dimensional images for respective lines output from an image sensor, thereby acquiring a two-dimensional image, which may be stored in the image database 106a. The image acquiring unit 102a may perform a projective transformation (for example, a projective transformation to make an image appear as if it were photographed from the front) on images.

The uploading unit 102b uploads the images stored in the image database 106a to the cloud storage 206. The uploading unit 102b may automatically upload the images stored in the image database 106a to the cloud storage 206 or may (be operated manually to) upload the images stored in the image database 106a to the cloud storage 206 based on instructions by a user. In other words, the uploading unit 102b may store images (for example, updated images) in a shared folder on the cloud 200.

The monitoring unit 102c monitors images. The monitoring unit 102c may monitor the images stored in the cloud storage 206. The monitoring unit 102c may monitor the update dates and times of the images stored in the cloud storage 206 and make a determination of the update of the images. The monitoring unit 102c may monitor the contents of the images stored in the cloud storage 206 and make a determination of the update of the images. The monitoring unit 102c may monitor the status of the images stored in any one or both of the image database 106a and the cloud storage 206. The monitoring unit 102c may monitor the images stored in the cloud storage 206 and acquire list information on the status of the images stored in the cloud storage 206. The monitoring unit 102c may monitor images automatically downloaded from (synchronized with) the cloud storage 206. In other words, the monitoring unit 102c may monitor whether images are newly stored in the shared folder on the cloud 200.

The image processing unit 102d performs certain image processing on images. The image processing may be any one or both of OCR processing, upright correction processing, double-spread merging processing, and marker segmentation processing.

The display controlling unit 102e displays, in a list form distinctively, images stored only in the image database 106a, images stored only in the cloud storage 206, images that are stored in the cloud storage 206 corresponding to the images stored in the image database 106a and that are updated, and images that are stored in the cloud storage 206 corresponding to the images stored in the image database 106a and that are not updated. The updated images may be images subjected to image processing by a different terminal device 100 or the image-reading apparatus 400, or the like.

The images stored in the cloud storage 206 corresponding to the images stored in the image database 106a may be images stored in the cloud storage 206 that match the images stored in the image database 106a in terms of any one or both of identifier and file name. The display controlling unit 102e may display, in a list form distinctively, images stored only in the image database 106a, images stored only in the cloud storage 206, images that are stored in the cloud storage 206 corresponding to the images stored in the image database 106a and that are updated, and images that are stored in the cloud storage 206 corresponding to the images stored in the image database 106a and that are not updated. In other words, the display controlling unit 102e may display the images in the shared folder on the cloud 200 in a list form.

The downloading unit 102f downloads the images stored in the cloud storage 206 to the image database 106a. The downloading unit 102f may automatically download the images stored in the cloud storage 206 to the image database 106a or may (be operated manually to) download the images stored in the cloud storage 206 to the image database 106a based on instructions by a user. In other words, when the monitoring unit 102c detects (provides a notification) that any image is newly stored (saved) in the cloud storage 206, the downloading unit 102f may acquire the image from the cloud storage 206 (shared folder).

As shown in FIG. 1, the cloud 200 generally includes the cloud storage 206. The cloud 200 is a general cloud service (cloud computing) and may be one selected by a user in advance. In the present embodiment, the cloud 200 may include all the functions (for example, an image processing function) of the control unit 102 (a control unit 102-2 in particular) of the terminal device 100 (the PC 100-2 in particular) and may perform image processing or the like on images uploaded from the terminal device 100 (for example, the smart device 100-1) or the image-reading apparatus 400.

The cloud storage 206 is a storage unit that stores any one or both of various databases, various tables, and various files and stores images. The images may be images read by the image-reading apparatus 400. The images may be images uploaded from the terminal device 100 or the image-reading apparatus 400. The images may be updated images.

As shown in FIG. 1, the image-reading apparatus 400 may generally include a control unit 402, a storage unit 406, and an image reading unit 410, and in particular, may include such units when the image-reading apparatus 400 (for example, the image-reading apparatus 400-3) and the cloud 200 are directly communicably connected. The image-reading apparatus 400 may be a mobile image-reading apparatus (that is, a portable scanner or the like). Although omitted in FIG. 1, the image-reading apparatus 400 may further include an input/output unit (I/O unit) 412 or the like. The image-reading apparatus 400 may further include an overall conveyance roller or the like. The image-reading apparatus 400 may further include an input/output interface (not shown) connecting the input/output unit 412 and the control unit 402.

The image-reading apparatus 400 may further include a communication interface unit (not shown) and may be mutually communicably connected to an external apparatus (for example, any one or both of the terminal device 100 and the cloud 200) through the communication interface unit. The communication interface unit is an interface connected to a communication device such as any one or both of an antenna and a router connected to any one or both of a communication line and a telephone line and may have a function that performs communication control between the image-reading apparatus 400 and the network 300. These units are communicably connected through any communication channels. The control unit 402 may control the input/output unit (I/O unit) 412, the input/output interface unit, and the communication interface unit.

The storage unit 406 stores any one or both of various databases, various tables, and various files. The storage unit 406 is a storage unit, which may be, for example, any one or both of a memory such as a RAM and a ROM, a fixed disk device such as a hard disk, a flexible disk, and an optical disc. The storage unit 406 stores a computer program or the like that gives instructions to a CPU to perform various kinds of processing.

Among these components of the storage unit 406, an image database 406a stores images. The images may be images read by the image reading unit 410. The images may be images downloaded from the cloud 200. The images may be updated images. The updated images may be images subjected to image processing by the terminal device 100 (the smart device 100-1, the PC 100-2, or the like), a different image-reading apparatus 400, or the like.

The image reading unit 410 scans a medium (document) and reads an image of the medium (document). The image reading unit 410 may scan a plurality of media simultaneously and read an image of the media. The image reading unit 410 may start the reading of an image concurrently with the start of paper conveyance to a conveyance path. In the present embodiment, the image reading unit 410 may have an image sensor such as a contact image sensor (CIS). The image reading unit 410 may have a light source such as an RGB three-color LED. The image sensor may convert signals of light-receiving elements arranged one-dimensionally into serial output signals. One-dimensional images are thus output for respective lines, and the control unit 402 combines the images to form a two-dimensional image.

The input/output unit 412 performs the inputting and outputting (I/O) of data. The input/output unit 412 may be, for example, a key input unit, a touch panel, a control pad (for example, a touch pad or a game pad), a mouse, a keyboard, or a microphone. The input/output unit 412 may be a display unit (for example, a display including liquid crystals or organic EL, a monitor, or a touch panel) that displays display screens for applications or the like. The input/output unit 412 may be a voice output unit (for example, a speaker) that outputs voice information as voices.

The control unit 402 includes a CPU or the like that comprehensively controls the image-reading apparatus 400. The control unit 402 has an internal memory for storing a control program, a program that prescribes various kinds of process procedures, and necessary data and performs information processing for executing various kinds of processing based on these programs.

The control unit 402 roughly includes an image acquiring unit 402a, an uploading unit 402b, a monitoring unit 402c, an image processing unit 402d, a display controlling unit 402e, and a downloading unit 402f.

The image acquiring unit 402a acquires images. The image acquiring unit 402a may acquire images read by the image-reading unit 410. The image acquiring unit 402a may store images or the like in the image database 406a. The image acquiring unit 402a may cause the image-reading unit 410 to read a medium (document) and acquire an image. The image acquiring unit 402a may cause the image-reading unit 410 to read a plurality of documents simultaneously and acquire read images. In other words, the image acquiring unit 402a may control the image-reading unit 410 to acquire images. The image acquiring unit 402a, for example, may control the image-reading unit 410 to combine one-dimensional images for respective lines output from an image sensor, thereby acquiring a two-dimensional image, which may be stored in the image database 406a. The image acquiring unit 402a may perform a projective transformation (for example, a projective transformation to make an image appear as if it were photographed from the front) on images.

The uploading unit 402b uploads the images stored in the image database 406a to the cloud storage 206. The uploading unit 402b may automatically upload the images stored in the image database 406a to the cloud storage 206 or may (be operated manually to) upload the images stored in the image database 406a to the cloud storage 206 based on instructions by a user. In other words, the uploading unit 402b may store images (for example, updated images) in the shared folder on the cloud 200.

The monitoring unit 402c monitors the images stored in the cloud storage 206. The monitoring unit 402c may monitor the update dates and times of the images stored in the cloud storage 206 and make a determination of the update of the images. The monitoring unit 402c may monitor the contents of the images stored in the cloud storage 206 and make a determination of the update of the images. The monitoring unit 402c may monitor images automatically downloaded from (synchronized with) the cloud storage 206. In other words, the monitoring unit 402c may monitor whether images are newly stored in the shared folder on the cloud 200.

The image processing unit 402d performs certain image processing on images. The image processing may be any one or both of OCR processing, upright correction processing, double-spread merging processing, and marker segmentation processing.

The display controlling unit 402e displays, in a list form distinctively, images stored only in the image database 406a, images stored only in the cloud storage 206, images that are stored in the cloud storage 206 corresponding to the images stored in the image database 406a and that are updated, and images that are stored in the cloud storage 206 corresponding to the images stored in the image database 406a and that are not updated. The updated images may be images subjected to image processing by the terminal device 100 or a different image-reading apparatus 400, or the like. The images stored in the cloud storage 206 corresponding to the images stored in the image database 406a may be images stored in the cloud storage 206 that match the images stored in the image database 406a in terms of any one or both of identifier and file name. In other words, the display controlling unit 402e may display the images in the shared folder on the cloud 200 in a list form.

The downloading unit 402f downloads the images stored in the cloud storage 206 to the image database 406a. The downloading unit 402f may automatically download the images stored in the cloud storage 206 to the image database 406a or may (be operated manually to) download the images stored in the cloud storage 206 to the image database 406a based on instructions by a user. In other words, when the monitoring unit 402c detects (provides a notification) that any image is newly stored (saved) in the cloud storage 206, the downloading unit 402f may acquire the image from the cloud storage 206 (shared folder).

2. Processing According to the Present Embodiment

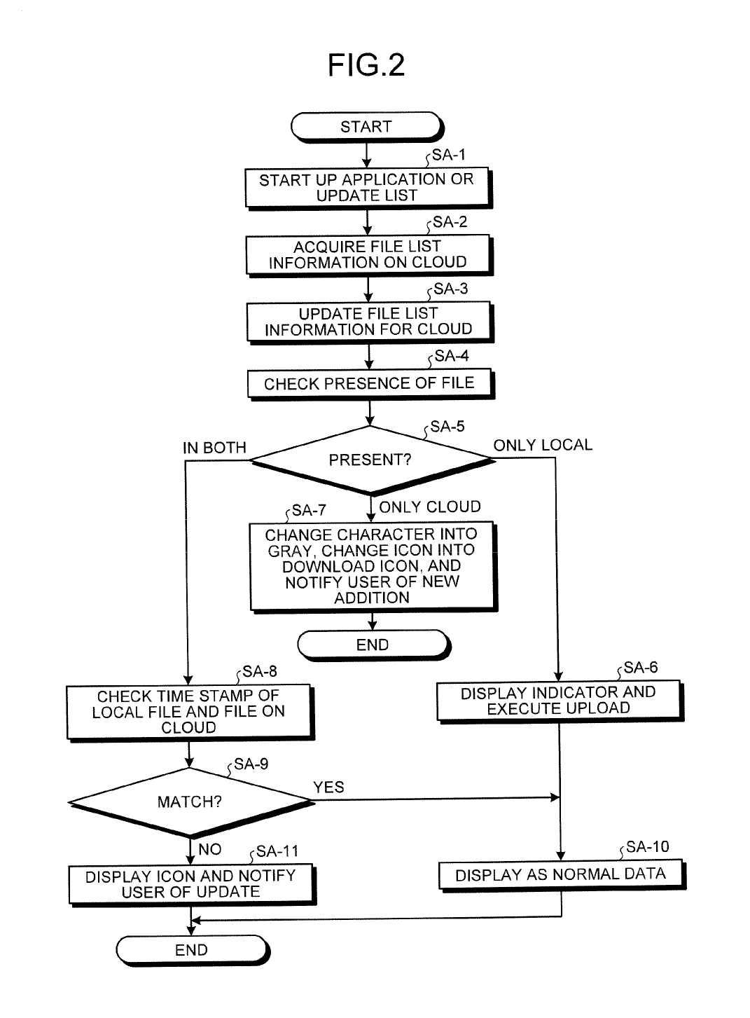

The following explains an example of processing executed by the thus configured information processing system with reference to FIG. 2 to FIG. 12.

File Listing Processing

First, an example of file listing processing according to the present embodiment is described with reference to FIG. 2 to FIG. 11. FIG. 2 is a flowchart of an example of processing according to the information processing system of the present embodiment.

As shown in FIG. 2, first, when a user inputs an instruction to start up an application through an input/output unit 112-1 or to update the list display of a list displayed by a display controlling unit 102e-1 on the input/output unit 112-1, a monitoring unit 102c-1 of the smart device 100-1 detects the instruction (Step SA-1).

The monitoring unit 102c-1 of the smart device 100-1 monitors the images (files) stored in the cloud storage 206 on the cloud 200 and acquires file list information on the status of the files stored in the cloud storage 206 (Step SA-2).

The monitoring unit 102c-1 of the smart device 100-1 updates file list information for the cloud 200 in which files are stored in an image database 106a-1 (Step SA-3).

The monitoring unit 102c-1 of the smart device 100-1 checks the status (presence) of the files (Step SA-4).

The monitoring unit 102c-1 of the smart device 100-1 determines what status the files are in, that is, where the files are present, based on the matched or mismatched status of the images in terms of any one or both of the identifier and file name (SA-5). In the present embodiment, when the file names of images present in any of the smart device 100-1, the PC 100-2, the cloud 200, and the image-reading apparatuses 400 are changed, the file names of images present in the smart device 100-1, the PC 100-2, the cloud 200, and the image-reading apparatuses 400 and corresponding to the foregoing images may be automatically changed.

If the monitoring unit 102c-1 determines that the files are present only in the image database 106a (local) (ONLY LOCAL at Step SA-5), the display controlling unit 102e-1 of the smart device 100-1 displays the files (a thumbnail of the files) and an indicator that clearly expresses the upload condition of the files in the input/output unit 112-1, and the uploading unit 102b uploads the files stored in the image database 106a-1 to the cloud storage 206 (Step SA-6). After the completion of the upload, the processing is shifted to Step SA-10.

If the monitoring unit 102c-1 determines that the files are present only in the cloud storage 206 (ONLY CLOUD at Step SA-5), the display controlling unit 102e-1 of the smart device 100-1 changes the characters of the file names or the like into gray, displays the files (the thumbnail of the files) with the icon being a download icon indicating that the files are present only in the cloud storage 206 in the input/output unit 112-1, and notifies the user of the new addition (Step SA-7), thereby ending the processing.

If the monitoring unit 102c-1 of the smart device 100-1 determines that the files are present in both the image database 106a-1 and the cloud storage 206 (IN BOTH at Step SA-5), it checks the update dates and times (time stamps) of the files (local files) stored in the image database 106a and the files (files on the cloud) stored in the cloud storage 206 that match the local files in terms of any one or both of identifier and file name (Step SA-8).

The monitoring unit 102c-1 of the smart device 100-1 determines whether there is any match between the time stamps, in other words, whether the images are updated by the PC 100-2 or the cloud 200 (Step SA-9).

If the monitoring unit 102c-1 of the smart device 100-1 determines that there is any match between the time stamps (Yes at Step SA-9), the processing is shifted to Step SA-10.

The display controlling unit 102e-1 of the smart device 100-1 displays, as normal data (in a normal manner), the files (the thumbnail of the files) determined to be present in the both by the monitoring unit 102c-1 in the input/output unit 112-1 (Step SA-10), thereby ending the processing.

If the monitoring unit 102c-1 determines that there is no match between the time stamps (No at Step SA-9), the display controlling unit 102e-1 of the smart device 100-1 displays the files (the thumbnail of the files) determined to be present in the both by the monitoring unit 102c-1 and an update icon indicating that the time stamps are different between the cloud storage 206 and the smart device 100-1 in the input/output unit 112-1, and notifies the user of the update (Step SA-11), thereby ending the processing.

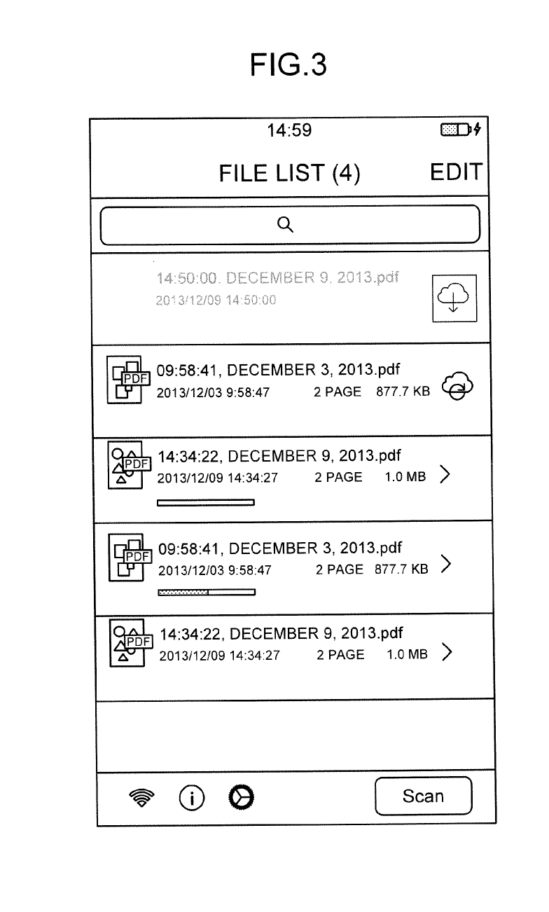

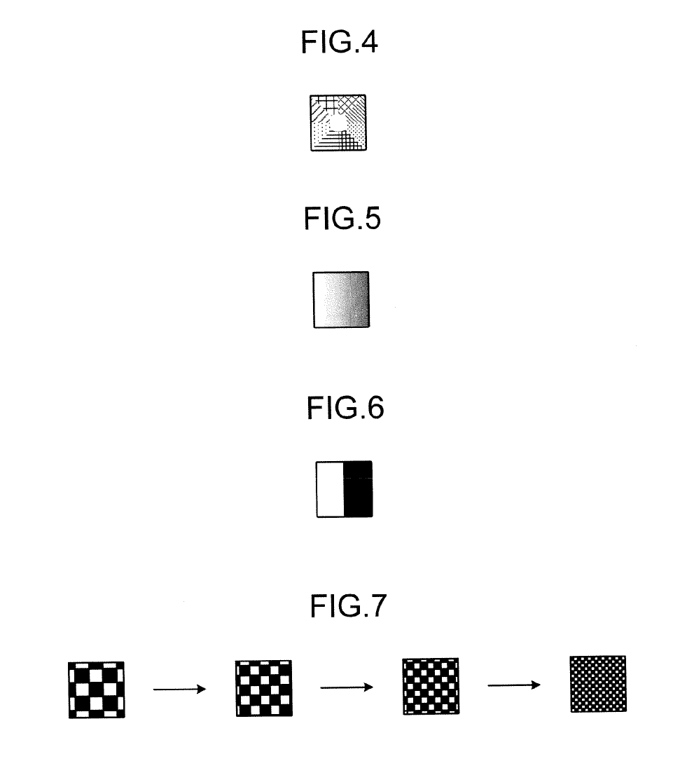

An example of screen display according to the present embodiment is explained with reference to FIG. 3 to FIG. 11. FIG. 3 is a diagram of an example of screen display according to the present embodiment. FIG. 4 to FIG. 11 are pictures of examples of icons according to the present embodiment.

As shown in FIG. 3, as can be seen by the uppermost file of the file list, the display controlling unit 102e-1 of the smart device 100-1 may display characters in gray and display an icon with a download icon for the files present only on the cloud 200. As shown in FIG. 3, as can be seen by the second uppermost file of the file list, the display controlling unit 102e-1 of the smart device 100-1 may display a reduced picture of an image and a file type with a thumbnail, display characters in black, and display an icon with an update icon for the files that are present in both the image database 106a-1 and the cloud 200 with unmatched contents.

As shown in FIG. 3, as can be seen by the third and fourth uppermost files of the file list, the display controlling unit 102e-1 of the smart device 100-1 may display a reduced picture of an image and a file type with a thumbnail, display characters in black, and display a progress bar so as to indicate the upload status of the files present only in the image database 106a-1 (local). As shown in FIG. 3, as can be seen by the fifth uppermost (lowest) file of the file list, the display controlling unit 102e-1 of the smart device 100-1 may display a reduced picture of an image and a file type with a thumbnail and display characters in black for the files that are present in both the image database 106a-1 and the cloud 200 with matched contents.

The display controlling unit 102e-1 of the smart device 100-1 may display the files present in the image database 106a-1 (local) with icons so as to distinguish the status of the files (for example, contents subjected to image processing (editing) by the image-reading apparatus (scanner) 400 or the PC 100-2).

As shown in FIG. 4 to FIG. 6, for example, the display controlling unit 102e-1, with respect to the color modes of files, may display an icon (FIG. 4) indicating that it is Color, an icon (FIG. 5) indicating that it is Grayscale, and an icon (FIG. 6) indicating that it is Monochrome.

As shown in FIG. 7, the display controlling unit 102e-1 may display the icons changed so as to indicate, with respect to the resolution of files, that the resolution increases from “normal,” “fine, “super fine,” to “excellent” in the arrow direction.

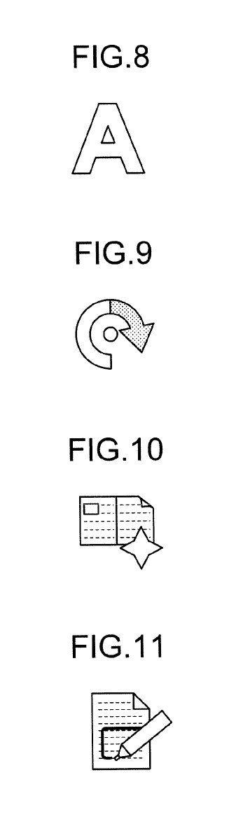

As shown in FIG. 4 to FIG. 6, the display controlling unit 102e-1 may display, with respect to specific image processing performed by the image-reading apparatus 400 or the PC 100-2, any one or both of an icon (FIG. 8) indicating OCR processing, an icon (FIG. 9) indicating upright correction processing, an icon (FIG. 10) indicating double-spread merging processing, and an icon (FIG. 11) indicating marker segmentation processing. Although not shown, the display controlling unit 102e-1 may display any one or both of an icon indicating document size, an icon indicating password-protected processing, an icon indicating PDF formatting, an icon indicating blank-paper removing processing, and an icon indicating noise removing processing.

Thus, in the present embodiment, provided is a method of display that allows users to clearly comprehend the status of the files on the cloud storage 206 and the files present in the image database 106a (local). In the present embodiment, for example, the files on the cloud storage 206 may be displayed without being downloaded, with the resources and light operation feeling of the smart device 100-1 taken into consideration. In the present embodiment, when files are present in different locations between the cloud storage 206 and the image database 106a (local) on a file list screen, they may be displayed so as to indicate that they are present in different locations.

In the present embodiment, upload of local files to the cloud storage 206 and download from the cloud storage 206 may be displayed so as to be distinguishable from each other. In the present embodiment, corrections (for example, correction of any one or both of color mode, document size, and resolution) on the image-reading apparatus (scanner) 400 and updates (for example, any one or both of OCR processing, upright correction processing, double-spread merging processing, and marker segmentation processing) on the PC 100-2 may be displayed so as to be distinguishable from one another.

In the present embodiment, files present in the cloud 200 and files that are present in the PC 100-2 and that correspond to the foregoing files may be synchronized, and then, when the files are changed or deleted on the cloud 200 (or the PC 100-2), files present in the PC 100-2 (or the cloud 200) and corresponding to the foregoing files may be automatically changed or deleted. In the present embodiment, when files are changed or deleted on the cloud 200 (or the smart device 100-1), files present in the smart device 100-1 (or the cloud 200) and corresponding to the foregoing files may be left unchanged or undeleted.

File acquisition processing

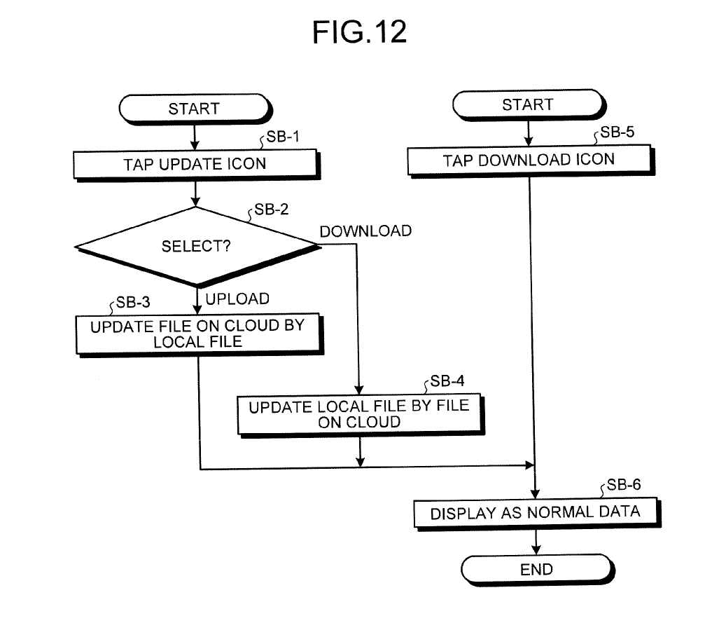

Next, an example of file acquisition processing on the cloud according to the present embodiment is explained with reference to FIG. 12. FIG. 12 is a flowchart of an example of processing according to the information processing system of the present embodiment.

As shown in FIG. 12, first, when images are updated on the cloud 200 (cloud storage 206) and the display controlling unit 102e-1 notifies a user of the update, a control unit 102-1 of the smart device 100-1 checks whether the user taps the update icon through the input/output unit 112-1 (Step SB-1).

If the user taps the update icon through the input/output unit 112-1, the control unit 102-1 of the smart device 100-1 determines whether the user selects files stored in the image database 106a (local) or files stored in the cloud storage 206 (Step SB-2).

If the control unit 102-1 determines that the user selects the files stored in the image database 106a (local) (upload at Step SB-2), an uploading unit 102b-1 of the smart device 100-1 updates, with the files in the image database 106a (local), the files in the cloud storage 206 that match the local files in terms of any one or both of identifier and file name (Step SB-3), and then shifts the processing to Step SB-6.

If the control unit 102-1 determines that the user selects the files stored in the cloud storage 206 (download at Step SB-2), a downloading unit 102f-1 of the smart device 100-1 updates, with the files in the cloud storage 206, the files stored in the image database 106a (local) that match the files in the cloud 200 in terms of any one or both of identifier and file name (Step SB-4), and then shifts the processing to Step SB-6.

When files are stored (saved) on the cloud 200 (cloud storage 206), the files are present only in the cloud 200 in some cases. In such a case, if the user is notified of the update by the display controlling unit 102e-1 and taps a download icon through the input/output unit 112-1, the downloading unit 102f-1 of the smart device 100-1 downloads the files stored only in the cloud storage 206 to the image database 106a (Step SB-5), and then shifts the processing to Step SB-6.

The display controlling unit 102e-1 of the smart device 100-1 displays the files (a thumbnail of the files) as normal data (in a normal manner) in the input/output unit 112-1 (Step SB-6), thereby ending the processing.

Thus, in the present embodiment, data scanned by a program of the smart device 100-1 (a smartphone or a tablet terminal) can be synchronized, and any one or both of automatic OCR and upright correction can be performed. For example, in the present embodiment, the program of the smart device 100-1 receives data scanned by the scanner 400-1 on the side of the smart device 100-1 and automatically sends it to the cloud storage 206. In the present embodiment, a program (Cloud Client) of the PC 100-2 automatically sends the scan data sent to the cloud storage 206 to an image database (synchronized folder) 106a-2 of the PC 100-2.

In the present embodiment, the monitoring unit 102c of the PC 100-2 monitors the synchronized folder 106a-2 of the PC 100-2 and detects that new scan data is sent. In the present embodiment, an image processing unit 102d-1 of the PC 100-2 performs any one or both of OCR and upright correction on the detected new scan data, updates the scan data, and stores the updated scan data in the synchronized folder 106a-2 of the PC 100-2. In the present embodiment, Cloud Client sends the updated scan data to the cloud storage 206. In the present embodiment, the program of the smart device 100-1 can refer to the updated scan data on the cloud storage 206.

In the present embodiment, data scanned by the PC 100-2 can be synchronized. In the present embodiment, for example, the program of the PC 100-2 receives data scanned by the scanner 400-2 on the side of the PC 100-2 and newly stores it in the synchronized folder 106a-2 of the PC 100-2. In the present embodiment, Cloud Client sends the scan data newly stored in the synchronized folder 106a-2 of the PC 100-2 to the cloud storage 206. In the present embodiment, the program of the smart device 100-1 can refer to the updated scan data on the cloud storage 206.

In the present embodiment, when an application is started up on the smart device 100-1, or when display update is performed on the screen after the startup, the latest list information is acquired from the cloud storage 206, and the list information on the cloud storage 206 and information on the files stored locally are compared with each other. In the present embodiment, correction processing (any one or both of color mode changing processing, document size changing processing, resolution changing processing, OCR processing, upright correction processing, double-spread merging processing, and marker segmentation processing) performed by the scanner 400 or the PC 100-2 may be displayed so as to be distinguishable by icons. In the present embodiment, this enables the user to recognize the status of the files based on the contents displayed to the user and to perform subsequent processing smoothly.

In the present embodiment, data updated by the PC 100-2 can be synchronized. In the present embodiment, for example, data changed on the PC 100-2 is detected by the smart device 100-1, and an update icon is displayed on a list. In the present embodiment, the user selects the update icon and selects update or download, thereby enabling the data on the PC 100-2 and the data on the smart device 100-1 to be synchronized with each other. In other words, in the present embodiment, upload that updates the data on the PC 100-2 by the data on the smart device 100-1 and upload that updates the data on the smart device 100-1 by the data on the PC 100-2 can be performed.

Although each device, that is, the PC 100-2 (Win/Mac) or the smart device 100-1 (iOS/Android or the like) is able to store data read by the scanner 400, each scan data is closed within each device and cannot be easily referred to and utilized. The present embodiment enables scan data of different devices to be easily referred to and utilized through synchronization therewith on any device, and also enables, the status of the scan data and local presence or absence thereof to be easily recognized for effective utilization of resources limited by the smart device 100-1, which is powerless.

3. Other Embodiments

The embodiment of the present invention is explained above. However, the present invention may be implemented in various different embodiments other than the embodiment described above within a technical scope described in claims.

For example, the terminal device 100 and the image-reading apparatus 400 may perform processing in the stand-alone form and may perform processing in response to requests from a client terminal (which is separated from the terminal device 100 or the image-reading apparatus 400) and return its processed results to the client terminal.

All the automatic processes explained in the present embodiment can be, entirely or partially, carried out manually. Similarly, all the manual processes explained in the present embodiment can be, entirely or partially, carried out automatically by a known method.

The process procedures, the control procedures, specific names, information including registration data for each process and various parameters such as search conditions, display example, and database construction, mentioned in the description and drawings can be changed as required unless otherwise specified.

The constituent elements of the terminal device 100, the cloud 200, and the image-reading apparatus 400 are merely conceptual and may not necessarily physically resemble the structures shown in the drawings.

For example, the process functions performed by each device of the terminal device 100, the cloud 200, and the image-reading apparatus 400, especially the each process function performed by the control unit 102 and the control unit 402, can be entirely or partially realized by CPU and a computer program executed by the CPU or by a hardware using wired logic. The computer program, recorded on a non-transitory tangible computer readable recording medium including programmed commands for causing a computer to execute the method of the present invention, can be mechanically read by the terminal device 100 as the situation demands. In other words, the storage unit 106 such as a ROM or a hard disk drive (HDD) stores the computer program that can work in coordination with an operating system (OS) to issue commands to the CPU and cause the CPU to perform various processes. The computer program is first loaded to the random access memory (RAM), and forms the control unit in collaboration with the CPU.

Alternatively, the computer program can be stored in any application program server connected to the terminal device 100, the cloud 200, and the image-reading apparatus 400 via any network, and can be fully or partially loaded as the situation demands.

The computer program may be stored in a computer-readable recording medium, or may be structured as a program product. Here, the “recording medium” includes any “portable physical medium” such as a memory card, a USB (universal serial bus) memory, an SD (secure digital) card, a flexible disk, an optical disk, a ROM, an EPROM (erasable programmable read only memory), an EEPROM (electronically erasable and programmable read only memory), a CD-ROM (compact disc read only memory), an MO (magneto-optical disc), a DVD (digital versatile disc), and a Blu-ray (registered trademark) disc.

In addition, a “program” is a data processing method that is described in any language or by a description method and may have any suitable form such as a source code, a binary code, or the like. Furthermore, the “program” is not necessarily limited to a configuration of a single form and includes a configuration in which the program is configured by a plurality of modules or a plurality of program libraries in a distributed manner and includes a program that achieves the function thereof in cooperation with a separate program that is represented by an OS. In addition, as a specific configuration for reading data from a recording medium in each apparatus illustrated in the embodiments, a reading procedure, an installation procedure after the reading, and the like, a known configuration and a known procedure may be used.

A variety of databases stored in the storage unit 106, the cloud storage 206 and the storage unit 406 is a storage unit such as a memory device such as a RAM or a ROM, a fixed disk device such as a HDD, a flexible disk, and an optical disk, and stores various programs, tables, databases, and web page files used for providing various processing or web sites.

The terminal device 100 may be structured as an information processing apparatus such as known personal computers or workstations, or may be structured by connecting any peripheral devices to the information processing apparatus. Furthermore, the terminal device 100 may be realized by mounting software (including programs, data, or the like) for causing the information processing apparatus to implement the method according of the invention.

The distribution and integration of the device are not limited to those illustrated in the figures. The device as a whole or in parts can be functionally or physically distributed or integrated in any desirable unit according to various attachments or how the device is to be used. That is, any embodiments described above can be combined when implemented, or the embodiments can selectively be implemented.

The present invention can provide a user interface that enables easy recognition of completion of stress-free synchronization on smart devices, and enables easy recognition of status display (synchronization completed, synchronization not completed, the file management status on smart devices, and the like) of files.

The present invention makes it possible to easily recognize from a file list what status files are in.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal device comprising:
an image storage unit that stores images;
a monitoring unit that monitors images stored in a cloud storage; and
a display controlling unit that displays, in a list form distinctively,
the images stored only in the image storage unit;
the images stored only in the cloud storage;
the images that are stored in the cloud storage, that correspond to the images stored in the image storage unit, and that are updated; and
the images that are stored in the cloud storage, that correspond to the images stored in the image storage unit, and that are not updated.

2. The terminal device according to claim 1, wherein the monitoring unit monitors the update dates and times of the images stored in the cloud storage and makes a determination of the update of the images.

3. The terminal device according to claim 1, wherein the monitoring unit monitors the contents of the images stored in the cloud storage and makes a determination of the update of the images.

4. The terminal device according to claim 1, wherein the images that are updated are images subjected to image processing by a terminal device different from the terminal device.

5. The terminal device according to claim 4, wherein the image processing is any one or both of OCR processing, upright correction processing, double-spread merging processing, and marker segmentation processing.

6. The terminal device according to claim 1, further comprising an image acquiring unit that acquires images read by an image-reading apparatus and stores the images in the image storage unit.

7. The terminal device according to claim 1, wherein the images stored in the cloud storage and corresponding to the images stored in the image storage unit are the images that are stored in the cloud storage and that match the images stored in the image storage unit in terms of any one or both of identifier and file name.

8. The terminal device according to claim 1, further comprising an uploading unit that uploads the images stored in the image storage unit to the cloud storage.

9. The terminal device according to claim 1, further comprising a downloading unit that downloads the images stored in the cloud storage to the image storage unit.

10. An image-reading apparatus comprising:
an image storage unit that stores images;
an image acquiring unit that acquires images read by an image reading unit and stores the images in the image storage unit;
a monitoring unit that monitors images stored in a cloud storage; and
a display controlling unit that displays, in a list form distinctively,
the images stored only in the image storage unit;
the images stored only in the cloud storage;
the images that are stored in the cloud storage, that correspond to the images stored in the image storage unit, and that are updated;
and the images that are stored in the cloud storage, that correspond to the images stored in the image storage unit, and that are not updated.

11. An information processing system comprising an image-reading apparatus, a terminal device, and a cloud storage that are communicably connected,
the terminal device including:
an image storage unit that stores images;
an image acquiring unit that acquires images read by the image reading apparatus and stores the images in the image storage unit;
a monitoring unit that monitors images stored in the cloud storage; and
a display controlling unit that displays, in a list form distinctively,
the images stored only in the image storage unit;
the images stored only in the cloud storage;
the images that are stored in the cloud storage, that correspond to the images stored in the image storage unit, and that are updated;
and the images that are stored in the cloud storage, that correspond to the images stored in the image storage unit, and that are not updated.

12. An information processing method executed by a terminal device, the method comprising:
a monitoring step of monitoring images stored in a cloud storage; and
a display controlling step of displaying, in a list form distinctively,
images stored only in an image storage unit included in the terminal device;
the images stored only in the cloud storage;
the images that are stored in the cloud storage, that correspond to the images stored in the image storage unit, and that are updated; and
the images that are stored in the cloud storage, that correspond to the images stored in the image storage unit, and that are not updated.

13. The information processing method according to claim 12, wherein the monitoring step includes monitoring update dates and times of the images stored in the cloud storage and making a determination of the update of the images.

14. The information processing method according to claim 12, wherein the monitoring step includes monitoring contents of the images stored in the cloud storage and making a determination of the update of the images.

15. The information processing method according to claim 12, wherein the images that are updated are images subjected to image processing by a terminal device different from the terminal device.

16. The information processing method according to claim 15, wherein the image processing is any one or both of OCR processing, upright correction processing, double-spread merging processing, and marker segmentation processing.

17. The information processing method according to claim 12, further comprising an image acquiring step of acquiring images read by an image-reading apparatus and storing the images in the image storage unit.

18. The information processing method according to claim 12, wherein the images stored in the cloud storage and corresponding to the images stored in the image storage unit are the images that are stored in the cloud storage and that match the images stored in the image storage unit in terms of any one or both of identifier and file name.

19. The information processing method according to claim 12, further comprising an uploading step of uploading the images stored in the image storage unit to the cloud storage.

20. The information processing method according to claim 12, further comprising a downloading step of downloading the images stored in the cloud storage to the image storage unit.
